(19) United States
(12) Patent Application Publication
(10) Pub. No.: US 2026/0179986 A1
(43) Pub. Date: Jun. 25, 2026

(54) COOLING CIRCUIT FOR FUEL CELL SYSTEM

(71) Applicant: Joby Aero, Inc., Santa Cruz, CA (US)

(72) Inventors: Sébastien Nicolas Jérôme Vermeiren, Munich (DE); Michael Patrick Tucker, Palo Alto, CA (US); Jeffrey Allen Lotterman, San Francisco, CA (US)

(21) Appl. No.: 19/423,846

(22) Filed: Dec. 17, 2025

Related U.S. Application Data
(60) Provisional application No. 63/736,434, filed on Dec. 19, 2024.

(51) Int. Cl. H01M 8/04746; B64D 27/355; B64D 29/00; B64D 33/10; H01M 8/04007; H01M 8/04029

(52) U.S. Cl. CPC H01M 8/04768; B64D 27/355; B64D 29/00; B64D 33/10; H01M 8/04029; H01M 8/04067; H01M 2250/20

(57) ABSTRACT

A cooling system for an aircraft fuel cell system includes a coolant pump to circulate coolant through the cooling system and a radiator to reject heat to ambient air. A cooler zone is provided downstream of the radiator, comprising a plurality of parallel cooling branches. A warmer zone is provided downstream of the cooler zone, the warmer zone including a fuel cell stack. A bypass valve is arranged to provide coolant to the warmer zone from upstream of the radiator. A restrictor may be arranged to provide coolant to the warmer zone from downstream of the radiator.

### RELATED APPLICATION DATA

This application claims the benefit of U.S. Application Ser. No. 63/736,434 filed Dec. 19, 2024, the contents of which are incorporated herein by reference as if explicitly set forth.

### TECHNICAL FIELD

This disclosure relates generally to the field of fuel cell systems that are fueled by hydrogen, including for example for use in electrically-powered or hybrid-powered aircraft.

### BACKGROUND

Fuel cell vehicles are powered by feeding hydrogen gas and air into an onboard fuel cell “stack,” which transforms the hydrogen's chemical energy into electrical energy. This electricity is then available to power the vehicle and its onboard systems.

Hydrogen supplied to a fuel cell comes into contact with a catalyst that promotes the separation of hydrogen atoms into an electron and proton. The electrons are gathered by a conductive current collector, which is connected to the vehicle's high-voltage circuitry, feeding an onboard battery and/or electric motors that propel the vehicle. The byproduct of the reaction occurring in the fuel cell stack is water vapor, which is emitted through an exhaust.

Operation of the fuel cell stack generates heat, which is removed by coolant flowing in a coolant circuit.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a plan view of a vehicles such as an aircraft, according to some examples.

FIG. 2 is a schematic view of an aircraft energy system, according to some examples.

FIG. 3 is a schematic diagram illustrating a hydrogen and air supply system for use in supplying a stack module of the fuel cell stack of the aircraft of FIG. 1, according to some examples.

FIG. 4 is a schematic diagram illustrating a cooling system for the fuel cell stack of the aircraft of FIG. 1, according to some examples.

FIG. 5A, FIG. 5B and FIG. 5C show a flowchart 500 illustrating operation of the energy supply system 200 according to some examples.

FIG. 6 illustrates a diagrammatic representation of a machine in the form of a computer system within which a set of instructions may be executed for causing the machine to perform any one or more of the methodologies discussed herein, according to some examples.

### DETAILED DESCRIPTION

The following description of examples of the invention is not intended to limit the invention to these examples, but rather to enable any person skilled in the art to make and use this invention.

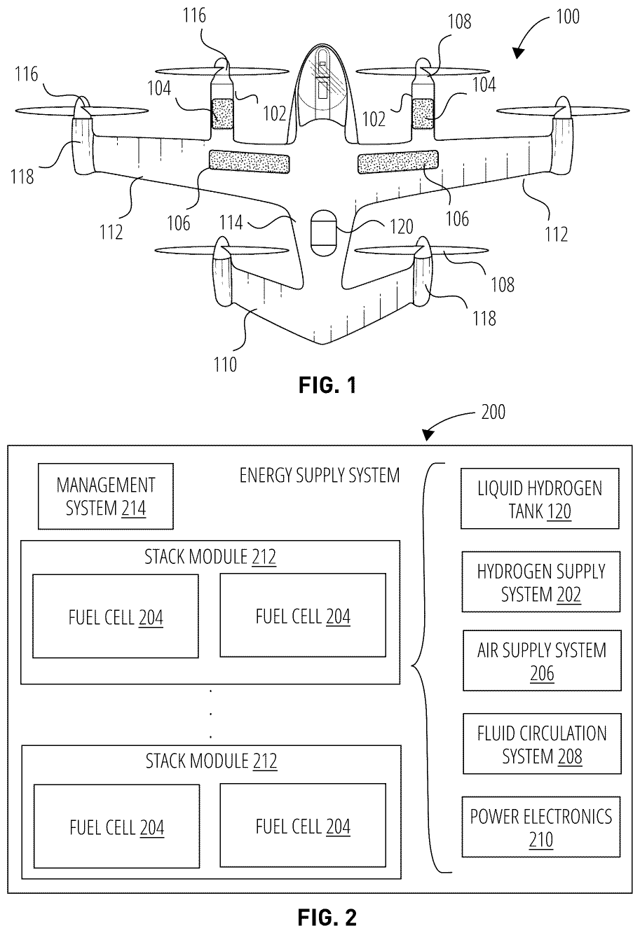

FIG. 1 is a plan view of a vehicle such as an aircraft 100 according to some examples. The aircraft 100 includes a fuselage 114, two wings 112, an empennage 110 and propulsion systems 108 embodied as tiltable rotor assemblies 116 located in nacelles 118, 102. The aircraft 100 includes one or more fuel cell stacks, in some examples embodied as nacelle fuel cell stacks 104 and wing fuel cell stacks 106, which are supplied with hydrogen from a liquid hydrogen tank 120. The aircraft 100 will typically include associated equipment such as an electronic infrastructure, control surfaces, a cooling system, landing gear and so forth.

The wings 112 function to generate lift to support the aircraft 100 during forward flight. The wings 112 can additionally or alternately function to structurally support the fuel cell stacks 104, 106 and/or propulsion systems 108 under the influence of various structural stresses (e.g., aerodynamic forces, gravitational forces, propulsive forces, external point loads, distributed loads, and/or body forces, and so forth).

FIG. 2 is a schematic view of an aircraft energy supply system 200 according to some examples. As shown, the energy supply system 200 includes one or more stack modules 212. Each stack module 212 includes one or more fuel cells 204.

Typically associated with a stack module 212 are a source of hydrogen such as a liquid hydrogen tank 120, a hydrogen supply system 202 for supplying hydrogen and air to the stack module 212 and for dealing with byproducts, an air supply system 206 for supplying air to the stack module 212 and for dealing with fuel cell exhaust, a fluid circulation system 208 for transferring heat, and power electronics 210 for regulating delivery of electrical power from the stack modules 212 during operation. The electronic infrastructure also includes an energy supply management system 214, for monitoring and controlling operation of the energy supply system 200 and to provide integration of the energy supply system 200 with the electronic infrastructure of the aircraft 100.

The stack modules 212 function to convert chemical energy into electrical energy for supply to the propulsion systems 108. Stack modules 212 can be arranged and/or distributed about the aircraft in any suitable manner. Fuel cell stacks can be arranged within wings (e.g., inside of an airfoil cavity), inside nacelles, and/or in any other suitable location on the aircraft.

The fluid circulation system 208 functions to transfer heat from or to various components of the aircraft 100, for example by circulating a working coolant fluid within a stack module 212 to remove heat generated during operation, to provide heat for evaporation of liquid hydrogen from the liquid hydrogen tank 120, or to remove heat from other heat-generating components within the aircraft 100. This heat is typically dissipated to the environment by an air/fluid heat exchanger.

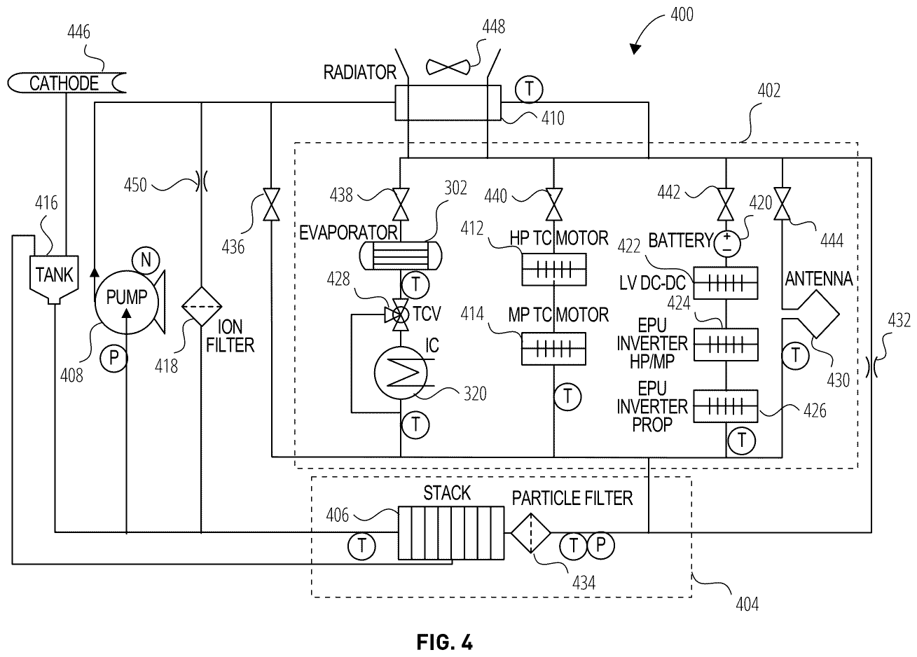

It is to be understood that the energy supply system 200 can, in other examples, analogously be implemented with alternative types of architectures, such as a hybrid fuel-cell powertrain architecture including electric batteries. Also, while cooling of a fuel cell/fuel cell stacks is disclosed herein, it will be appreciated that in some examples other power-generating units such as rechargeable battery packs can be cooled using the cooling system architecture of FIG. 4. Additionally, in some examples, the cooling system can be used in other vehicles.

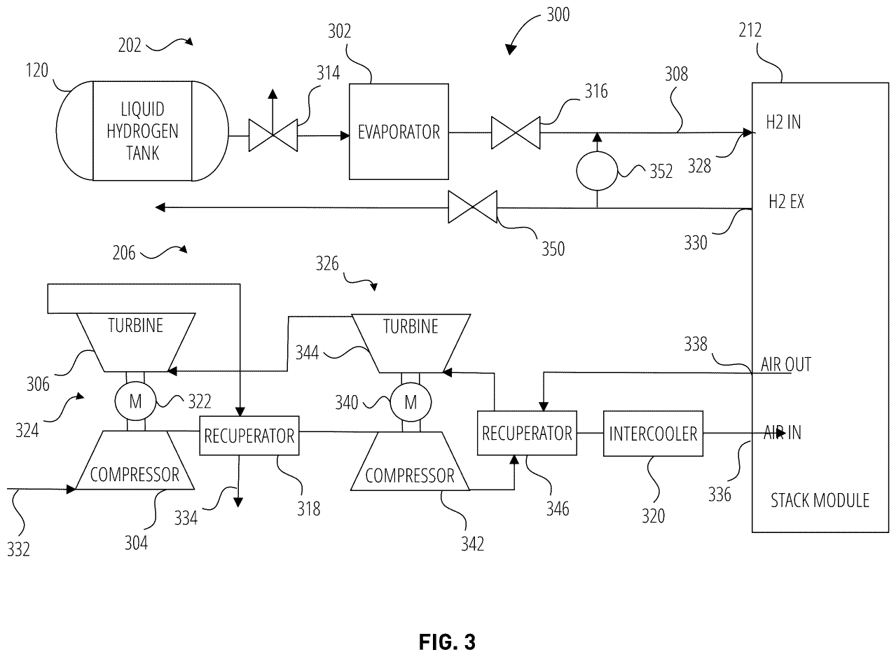

FIG. 3 is a schematic diagram illustrating a hydrogen and air supply system 300 for use in supplying a stack module 212 of the fuel cell stack of the aircraft of FIG. 1, according to some examples. The hydrogen and air supply system 300 includes an interconnected hydrogen supply system 202 and an air supply system 206. The hydrogen supply system 202 comprises a liquid hydrogen tank 120, an evaporator 302, and associated valves and supply lines. The air supply system 206 includes a combined medium-pressure turbine and compressor 324, a combined high-pressure turbine and compressor 326, an intercooler 320, recuperators 318, 346, and associated valves and supply lines. The medium-pressure turbine and compressor 324 receives ambient air from a cathode air intake 332 and returns cathode exhaust air to the ambient environment, after passing through the recuperator 318, via an exhaust 334.

The liquid hydrogen tank 120, as its name suggests, stores liquid hydrogen for use in the stack module 212. The liquid hydrogen tank 120 is connected to, and supplies liquid hydrogen to the evaporator 302. The evaporator 302 includes a pump that pressurizes the liquid hydrogen and a heat exchanger that evaporates and expands the liquid hydrogen to approximately the temperature required by the stack module 212, and to a pressure above that required by the stack module 212. Hydrogen gas leaving the evaporator 302 is provided to the hydrogen inlet 328 of the stack module 212 via supply line 308 via a valve 316. The valve 316 serves to regulate the pressure of the hydrogen gas supplied to the stack module 212 to a nominal fuel cell supply pressure.

Also provided in the supply line 308 from the liquid hydrogen tank 120 to the evaporator 302 is a purge valve 314, which serves to release pressure generated in the liquid hydrogen tank 120 due to evaporation of the hydrogen in the liquid hydrogen tank 120. Excess hydrogen purged by the purge valve 314 from the liquid hydrogen tank 120 is routed to an exhaust.

An excessive supply of hydrogen to the stack module 212 is generally required for high power vehicular applications. The excess hydrogen that is not consumed by the stack module 212, leaving via the hydrogen exhaust 330 of the stack module 212, is thus recycled back to the hydrogen inlet 328 via a blower 352. Excess hydrogen leaving the stack module 212 typically includes some water vapor and an accumulation of nitrogen. Hydrogen leaving the stack module 212 can periodically be purged through a purge valve 350 to alleviate this accumulation.

The medium-pressure turbine and compressor 324 includes a compressor 304, a turbine 306 and a motor 322. The compressor 304 compresses air received at a cathode air intake 332, after it has been filtered. The compressed air leaving the compressor 304 passes through the recuperator 318, where it loses heat, and is then passed to the high-pressure turbine and compressor 326.

The high-pressure turbine and compressor 326 includes a compressor 342, a turbine 344 and a motor 340. The compressor 342 further compresses the air received from the compressor 304 and the recuperator 318. The compressed air leaving the compressor 304 passes through the recuperator 346, where is cooled by exchanging heat with the cathode exhaust air leaving the stack module 212 via the cathode air exhaust outlet 338. Compressed air leaving the recuperator 346 is then cooled by coolant in the intercooler 320 before being provided to the stack module 212 via air inlet 336.

Exhaust air leaves the stack module 212 via the cathode air exhaust outlet 338. The exhaust air is routed to the recuperator 318 where it receives heat from the air compressed by the compressor 342. The exhaust air leaving the recuperator 346 is used to drive the turbine 344 of the high-pressure turbine and compressor 326.

The turbine 344 in the high-pressure turbine and compressor 326 is driven by the pressure differential between the air leaving the recuperator 346 and the air supplied to the turbine 306. The turbine 344 assists the motor 340 in driving the compressor 342, which compresses the inlet air as discussed above. The turbine 344 thus decreases the amount of work done by the motor 340 in compressing the inlet air, increasing the overall efficiency of the energy supply system 200.

The turbine 306 in the medium-pressure turbine and compressor 324 is in turn driven by the pressure differential between the air leaving the turbine 344 and the exhaust air supplied to recuperator 318. The turbine 306 assists the motor 322 in driving the compressor 304, which compresses the inlet air as discussed above. The turbine 306 thus decreases the amount of work done by the motor 322 in compressing the inlet air, increasing the overall efficiency of the energy supply system 200.

The recuperators 318, 346 can take various forms. These can be direct heat exchangers or indirect heat exchangers using an intermediary heat exchange fluid like coolant or refrigerant.

The turbines 306, 344 can alternatively be any other type of expansion engine that can be used to convert a pressure differential in a gas into work, such as for example a piston engine. Similarly, the compressor 304 can alternatively be any other mechanical device that can extract work from operation of the expansion engine, such as a dynamo or generator.

FIG. 4 is a schematic diagram illustrating a cooling system 400 for the hydrogen and air supply system 300 of the aircraft 100 of FIG. 1, according to some examples. The cooling system 400 comprises two primary thermal zones-a cooler zone 402 and a warmer zone 404. A coolant pump 408 circulates coolant through coolant pipes joining the other components of the cooling system 400, and a radiator 410 provides primary heat rejection to ambient air. As will be appreciated, a single coolant type is used in the cooling system 400.

The radiator 410 includes a radiator air flow control 448 to regulate heat rejection. In some examples the radiator 410 is cooled by airflow through a channel or duct that receives pressurized air from the front of the aircraft 100 during operation, and the radiator air flow control 448 is an aerodynamic fairing that is controllable to throttle the amount of air passing through the radiator 410. In some examples, the radiator air flow control 448 includes a fan, the speed or pitch of which can be varied by the energy supply management system 214, to regulate the amount of heat rejected through the radiator instead of or in addition to the aerodynamic fairing.

The cooler zone 402 includes several parallel branches that serve to cool various components, including a branch to cool the intercooler 320, a branch to cool the high pressure compressor motor 412 and the medium pressure compressor motor 414, a branch to cool a battery 420, a low voltage DC-DC converter 422 and EPU inverters 424, 426, and a branch to cool an antenna 430. Control branch valves 438, 440, 442, and 444 regulate the flow rates through the individual branches of the cooler zone 402. In some examples, the branch valves are located in a single valve block. The warmer zone 404 includes the fuel cell stack 406 and a particle filter 434.

Coolant flows from the radiator 410 through the multiple branches in the cooler zone 402, where it gains heat before passing through the fuel cell stack 406. The items in the cooler zone 402 benefit from the coldest possible coolant temperature, typically from 40-70 deg. C. The fuel cell stack 406 in the warmer zone 404, on the other hand, only requires a coolant temperature of approximately 70-85 deg. C. Heat from the components in the cooler zone 402 thus helps in raising the temperature of the coolant to an appropriate value for the fuel cell stack 406.

In addition to different temperature requirements, the fuel cell stack 406 and the components in the cooler zone 402 have different coolant flow rate requirements by approximately an order of magnitude. For example, the fuel cell stack 406 may require 200 or 300 liters per minute while each of the branches, may require 5 to 10 liters per minute. A controllable bypass valve 436 provides coolant to the fuel cell stack 406 from downstream of the coolant pump 408 but upstream of the radiator 410, and a restrictor 432 provides coolant to the fuel cell stack 406 from downstream of the radiator 410.

These two bypasses of the cooler zone 402 ensure that the higher coolant flow requirement of the fuel cell stack 406 is met. Additionally, the bypass valve 436 provides relatively warmer coolant that has not yet passed through the radiator 410 again, as required by the higher inlet temperature needed for the fuel cell stack 406. The flow coming from the bypass valve 436 mixes with the colder flow leaving the branches, raising the temperature of the combined flow reaching the fuel cell stack 406 compared to the branches of the cooler zone 402 alone.

The configuration of the cooling system 400 thus uses a single coolant pump 408 and a single radiator 410 in some examples, saving weight in the aircraft 100, while components with different coolant temperature and flowrate requirements receive appropriate coolant flow rates and temperatures.

Additional components in the cooling system 400 include an expansion tank 416 with an air space to accommodate coolant thermal expansion, an ion filter 418 in a bypass configuration to maintain coolant conductivity below maximum limits, and a particle filter 434 for coolant filtration. The cooling system 400 also includes an evaporator 302 and intercooler 320 integrated into the cooling system 400. The evaporator 302 provides heat for hydrogen evaporation while the intercooler 320 cools compressed cathode air as described above with reference to FIG. 3. The relative heat loads between these components vary based on fuel cell stack 406 operating conditions. Accordingly, a three-way valve 428 is provided that can bypass the intercooler 320 as needed.

It is beneficial if the air pressure in the fuel cell stack 406 at the cathode 446 is approximately at the pressure of the coolant in the cooling system 400, as discussed in more detail below. Accordingly, the airspace in the coolant expansion tank 416 that provides for coolant expansion is coupled to the cathode 446. The cooling system 400 including the amount of coolant, and the size and design (e.g., the use of baffles) of the coolant expansion tank 416 is chosen so that coolant can never enter the fuel cell stack 406 from the coolant expansion tank 416.

Various temperature and pressure and other sensors, the number, type and location of which may vary, are provided to permit control of the cooling system 400 in use. In some examples, the sensors include pressure sensors at the inlet of the coolant pump 408 and the inlet of the fuel cell stack 406, a pump speed sensor, a fluid conductivity sensor, and temperature sensors at the outlet of the radiator 410, at the outlet of the evaporator 302, at the downstream end of each branch in the cooler zone 402, and at the inlet and at the outlet of the fuel cell stack 406.

In some examples, flow restrictors may be used in place of control valves in the parallel branches in the cooler zone 402, to provide fixed flow distribution. The cooling system 400 is designed to maintain component temperatures within limits while providing appropriate thermal conditions for stack operation across various operating modes.

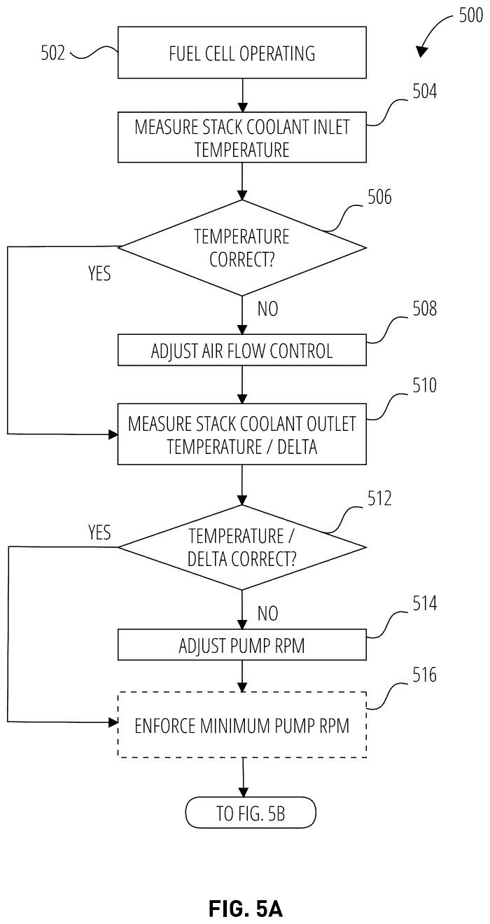

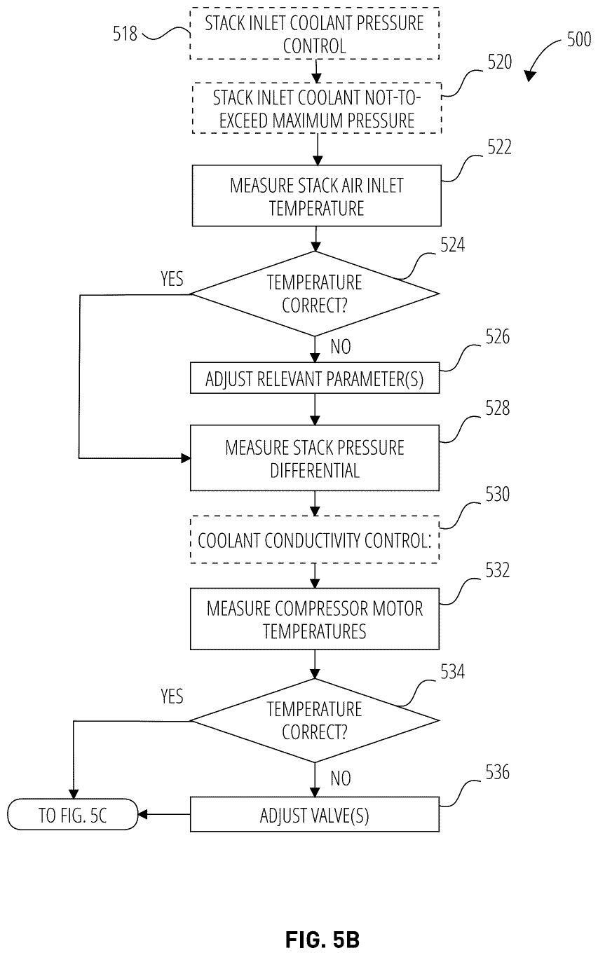

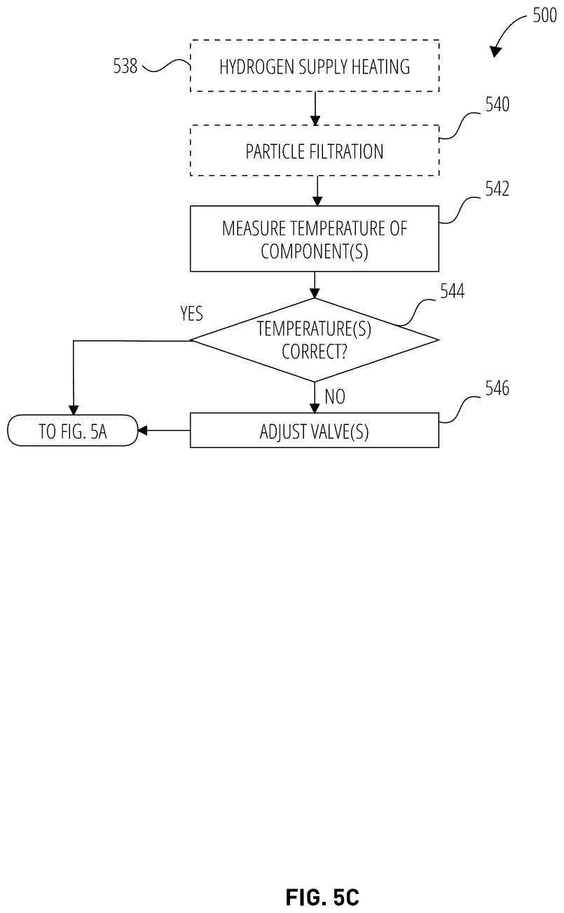

The system employs a mix of active and passive controls, with multiple control layers providing redundancy and optimization capabilities. The design emphasizes simplification where possible, with the potential of replacement of control valves with fixed restrictors in some branches in alternative examples. There are several control strategies for the cooling system as discussed below with reference to FIG. 5A and FIG. 5B.

FIG. 5A, FIG. 5B and FIG. 5C show a flowchart 500 illustrating operation of the energy supply system 200 according to some examples. For explanatory purposes, the operations of the flowchart 500 are described herein as occurring in serial, or linearly. However, multiple operations of the flowchart may occur in parallel. In addition, the operations of the flowchart need not be performed in the order shown and/or one or more blocks of the flowcharts need not be performed and/or can be replaced by other operations. The operations of the flowchart may be performed by various components of the energy supply system 200 under control of the energy supply management system 214, or by related systems and processors.

The flowchart 500 commences at operation 502, in which the fuel cell 204 is operating. Controlling the temperature of the coolant in the cooling system 400 at the inlet of the fuel cell stack 406 is a primary control mechanism. This temperature is controlled by the amount of air flowing through the radiator 410. Pressurized air from the exterior of the aircraft, either as a result of aircraft forward movement or the operation of the propulsion systems 108 (e.g., when hovering) is directed through the radiator 410 using an aerodynamic channel/fairing. The volume of air passing through the radiator 410 is controlled by adjusting the radiator air flow control 448, which in most cases is an aerodynamic fairing that is controllable to throttle the amount of air passing through the radiator 410.

As illustrated in FIG. 5A, in operation 504 the energy supply management system 214 measures the temperature at the inlet of the fuel cell stack 406. In operation 506, the energy supply management system 214 determines whether the temperature at the inlet of the fuel cell stack 406 is within appropriate limits. If not, the energy supply management system 214 adjusts the radiator air flow control 448 in operation 508 to enable more air to flow through the radiator 410 if the temperature is too high, or the energy supply management system 214 adjusts the radiator air flow control 448 to reduce the amount of air flowing through the radiator 410 if the temperature is too low.

The temperature differential across the fuel cell stack 406 is also important for maintaining proper stack operating conditions. The temperature differential is managed through pump speed adjustments to control flow rate of coolant through the fuel cell stack 406. There is a direct relationship between pump speed and the temperature differential. Higher flow rates result in smaller temperature differentials while lower flowrates result in higher temperature differentials across the fuel cell stack 406. In some examples, since the temperature at the inlet of the fuel cell stack 406 is controlled, the temperature differential can effectively be controlled by controlling the fuel cell stack 406 outlet temperature as a proxy for controlling the temperature differential.

In operation 510, the energy supply management system 214 measures the temperature at the outlet of the fuel cell stack 406. In operation 512, the energy supply management system 214 determines whether the temperature at the outlet of the fuel cell stack 406, or the temperature differential across the fuel cell stack 406 is within appropriate limits. If so, the flowchart continues at operation 516 If not, the energy supply management system 214 increases the speed of the coolant pump 408 to enable more coolant to flow through the fuel cell stack 406 if the temperature differential is too high, or the energy supply management system 214 decreases the speed of the coolant pump 408 to enable less coolant to flow through the fuel cell stack 406 if the temperature differential is too low, in operation 514.

A minimum coolant flow rate through the stack is required, though. In some examples there is no direct flow rate sensor that measures the coolant flow rate through the fuel cell stack 406. The flow rate through the stack can be inferred by pressure loss characterizations, determined by measuring the pressure differential across the fuel cell stack 406. This, in turn, is used to determine a minimum RPM floor value for pump operation. As indicated with dashed lines in operation 516, the minimum coolant flow rate through the stack in some examples is not controlled directly, but is ensured by enforcing the minimum operational speed for the coolant pump 408.

Controlling the stack inlet coolant pressure and enforcing a not-to-exceed maximum stack inlet coolant pressure maintains a balance between hydrogen, air, and coolant pressures in the fuel cell stack 406, which reduces the chance of leakage between the components containing these working fluids. Maintaining this balance is achieved by passive control through mechanical design, as illustrated by the dashed lines in operation 518 and operation 520. Control of the stack inlet coolant pressure is achieved by the use of the coolant expansion tank 416, which has an air space at the top to accommodate coolant expansion and contraction. The air space at the top of the coolant expansion tank 416 is connected to the air inlet at the cathode of the fuel cell stack 406, which creates an automatic pressure balancing system within the energy supply system 200. The maximum stack inlet coolant pressure is similarly controlled passively through the design of the cooling system 400, in particular the design and configuration of the expansion tank 416. Providing this coupling of the pressure of two of the three working fluids avoids the need to implement active pressure control in this instance, and having a pressurized cooling system 400 reduces the risk of cavitation in the pump.

The air temperature at the air inlet 336 of the fuel cell stack 406 is controlled in four layers. The primary control is the amount of coolant passed to the intercooler 320 by the three-way valve 428. The three-way valve 428 is controlled by the energy supply management system 214 to direct more coolant to the intercooler 320 if the inlet air temperature of the fuel cell stack 406 is too low, or vice versa. Alternatively, in some examples, a two-way valve is provided in the intercooler bypass line, and the flow of coolant through the intercooler 320 is controlled using this two-way valve and the branch valve 438 in combination.

Secondary control of the inlet air temperature of the fuel cell stack 406 is by means of the branch valve 438. The branch valve 438 is controlled by the energy supply management system 214 to direct more coolant to the intercooler 320 if the inlet air temperature of the fuel cell stack 406 is too high, or vice versa.

Tertiary control of the air inlet temperature of the fuel cell stack 406 is via adjustment of the bypass valve 436. The bypass valve 436 is controlled by the energy supply management system 214 to direct more coolant to bypass the cooler zone 402 if the inlet air temperature of the fuel cell stack 406 is too high, or vice versa.

Quaternary control of the air inlet temperature of the fuel cell stack 406 is via overall system flow rate modification, including for example pump speed.

As illustrated, in operation 522, the energy supply management system 214 measures the stack inlet air temperature. If the energy supply management system 214 determines in operation 524 that the measured temperature is within acceptable limits, the method proceeds to operation 528. If not, the energy supply management system 214 adjusts the relevant parameters to return the stack inlet air temperature to within acceptable limits in operation 526.

The conductivity of the coolant is passively controlled in operation 530 by means of the ion filter 418 installed in a bypass configuration with a restrictor 450. The conductivity of the coolant is monitored by the energy supply management system 214 and if it passes a known threshold then an alert is triggered to replace the ion filter 418. In some examples, if the conductivity passes a higher threshold, this triggers an instruction to the pilot to land the aircraft 100 at the first opportunity.

Control of the temperatures of the high pressure compressor motor 412 and medium pressure compressor motor 414 is performed primarily using the bypass valve 436, which is controlled by the energy supply management system 214 to direct more coolant to bypass the radiator 410 and the cooler zone 402 if the temperatures of the high pressure compressor motor 412 and medium pressure compressor motor 414 are too high or vice versa. This reduces the temperature of the coolant leaving the radiator 410 to the cooler zone 402. This reduction in flow leaving the radiator 410 occurs within limits, to ensure that the radiator 410 still manages to exchange the amount of heat required by the cooling system 400.

Secondary control of the temperatures of the high pressure compressor motor 412 and medium pressure compressor motor 414 is by means of the branch valve 440. The branch valve 440 is controlled by the energy supply management system 214 to direct more coolant to the high pressure compressor motor 412 and medium pressure compressor motor 414 if their temperatures are too high, or vice versa.

In operation 532, the energy supply management system 214 measures the temperatures of the compressor motors 412, 414. If the energy supply management system 214 determines in operation 534 that the measured temperature is within acceptable limits, the method proceeds to operation 538. If not, the energy supply management system 214 adjusts one or both of the bypass valve 436 and/or the branch valve 440 to return the temperatures to within acceptable limits, in operation 536. The method then proceeds to operation 538.

The coolant temperature control requirements for hydrogen supply line heating are less stringent. As discussed previously, heat is provided to hydrogen supplied from the liquid hydrogen tank 120 by the evaporator 302. No separate direct valve control of coolant flow through the evaporator 302 is needed, as illustrated by the dashed lines in operation 538. Flow through the evaporator is controlled by the design of the branch in the cooler zone 402 including the evaporator 302. In the example, this branch includes the intercooler 320. The amount of coolant through the evaporator 302 will thus vary as flow through the intercooler 320 is adjusted using the branch valve 438.

Coolant particle filtration control is achieved by the particle filter 434, which is located in the main coolant flow circuit path. Particle filtration control is passive as illustrated by the dashed lines in operation 540, accomplished by measuring the pressure differential across the particle filter 434. The pressure differential is monitored by the energy supply management system 214 and if it passes a known threshold then an alert is triggered to replace the particle filter 434.

Temperature control of the remaining components in the cooler zone 402, such as the battery 420, low voltage DC-DC converter 422, EPU inverter 424, EPU inverter 426, antenna 430 is likewise managed by the energy supply management system 214 using a combination of branch valves 442, 444 and the bypass valve 436, by monitoring temperatures at key points. In some examples, temperatures are inferred through characterization, for example by current draws.

In operation 542 the energy supply management system 214 measures the temperatures of the remaining components. If the energy supply management system 214 determines in operation 544 that the measured temperatures are within acceptable limits, the method returns to operation 504 in FIG. 5A and proceeds from there. If not, the energy supply management system 214 adjusts the relevant valves to return the temperatures to within acceptable limits, in operation 546. The method then returns to operation 504 in FIG. 5A and proceeds from there.

The configuration and control of the cooling system 400 provides various benefits. The components that are cooled in the cooler zone 402 each require, for example, a 5-10 l/min coolant flow rate. This is much lower than the coolant flow rate requirement of the fuel cell stack 406, which, for example, can be 270 l/min depending on the power-generating capacity of the fuel cell stack 406. Accordingly, the bypass valve 436 serves two functions. Firstly, to ensure an overall division of coolant flow through and past the cooler zone 402 so that the cooler zone 402 receives an appropriate level of coolant flow, while the warmer zone 404 including the fuel cell stack 406 gets an appropriate level of coolant flow. The coolant flow through the warmer zone 404 is the sum of the coolant flow through the cooler zone 402, the restrictor 432 and through the bypass valve 436. The restrictor 432 provides a minimum constant flow of coolant bypassing the cooler zone 402 to the fuel cell stack 406, to ease the operational requirements of the bypass valve 436.

Secondly, the bypass valve 436 also serves one or more temperature control functions as described herein. Further, by providing the cooler zone 402 upstream of the warmer zone 404, the components in the cooler zone benefit from the lowest temperature coolant flow directly from the radiator 410, while adding heat to the coolant before it reaches the warmer zone 404. Individual control of branches is permitted by the parallel branch arrangement in the cooler zone 402, with separate branch valves as needed.

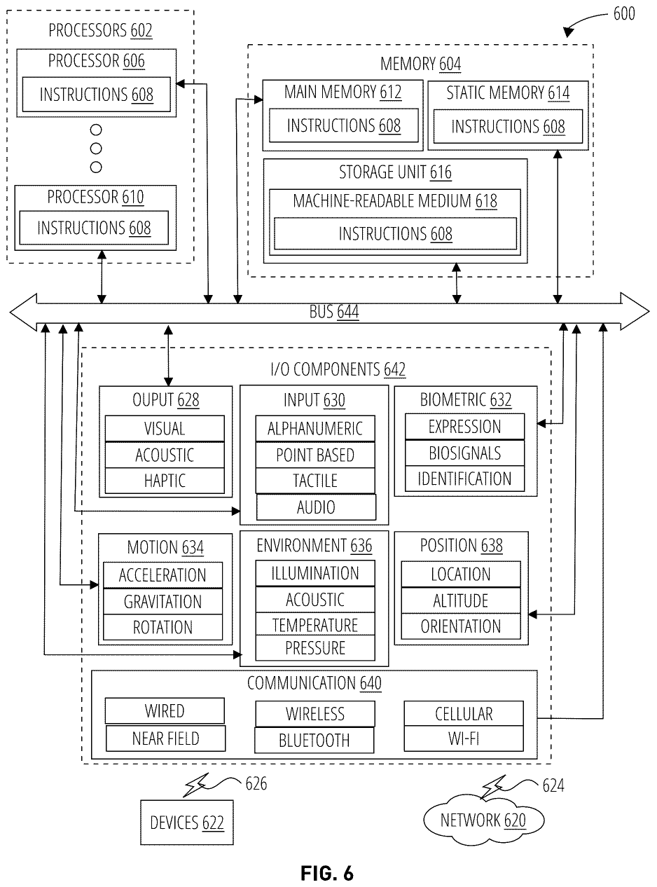

FIG. 6 illustrates a diagrammatic representation of a machine 600 in the form of a computer system within which a set of instructions may be executed for causing the machine to perform any one or more of the methodologies discussed herein, such as the energy supply management system 214 according to some examples. Specifically, FIG. 6 shows a diagrammatic representation of the machine 600 in the example form of a computer system, within which instructions 608 (e.g., software, a program, an application, an applet, an app, or other executable code) for causing the machine 600 to perform any one or more of the methodologies discussed herein may be executed. The instructions 608 transform the general, non-programmed machine 600 into a particular machine 600 programmed to carry out the described and illustrated functions in the manner described. In alternative examples, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines 600 that individually or jointly execute the instructions 608 to perform any one or more of the methodologies discussed herein.

The machine 600 may include processors 602, memory 604, and I/O components 642, which may be configured to communicate with each other such as via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that may execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 may include a main memory 612, a static memory 614, and a storage unit 616, both accessible to the processors 602 such as via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones will likely include a touch input device or other such input mechanisms, while a headless server machine will likely not include such a touch input device. It will be appreciated that the I/O components 642 may include many other components that are not shown in FIG. 6. The I/O components 642 are grouped according to functionality merely for simplifying the following discussion and the grouping is in no way limiting. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 may include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 604, main memory 612, static memory 614, and/or memory of the processors 602) and/or storage unit 616 may store one or more sets of instructions and data structures (e.g., software) embodying or utilized by any one or more of the methodologies or functions described herein. These instructions (e.g., the instructions 608), when executed by processors 602, cause various operations to implement the disclosed examples.

As used herein, the terms “machine-storage medium,” “device-storage medium,” “computer-storage medium” mean the same thing and may be used interchangeably in this disclosure. The terms refer to a single or multiple non-transitory storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 620 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 620 or a portion of the network 620 may include a wireless or cellular network, and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 608 may be transmitted or received over the network 620 using a transmission medium via a network interface device (e.g., a network interface component included in the communication components 640) and utilizing any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 608 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Various examples are contemplated. Example 1 is a cooling system for a vehicle, comprising: a coolant pump to circulate coolant through the cooling system; a radiator to reject heat to ambient air; a cooler zone downstream of the radiator and comprising a plurality of parallel cooling branches; a warmer zone downstream of the cooler zone, the warmer zone including a power supply unit; and an adjustable bypass valve arranged to provide an adjustable flow of coolant to the warmer zone from upstream of the radiator, bypassing the radiator and the cooler zone.

In Example 2, the subject matter of Example 1 includes, wherein the power supply unit is a fuel cell.

In Example 3, the subject matter of Examples 1-2 includes, a restrictor arranged to provide coolant to the warmer zone from downstream of the radiator.

In Example 4, the subject matter of Examples 1-3 includes, a control mechanism to control an amount of airflow through the radiator.

In Example 5, the subject matter of Example 4 includes, wherein the control mechanism comprises an adjustable aerodynamic fairing.

In Example 6, the subject matter of Examples 4-5 includes, wherein the control mechanism comprises a variable-speed or variable-pitch fan.

In Example 7, the subject matter of Examples 5-6 includes, a restrictor arranged to provide coolant to the warmer zone from downstream of the radiator.

In Example 8, the subject matter of Examples 1-7 includes, wherein each of the parallel cooling branches includes at least one heat generating component, at least some of the parallel cooling branches including an adjustable valve upstream of the corresponding heat generating component.

In Example 9, the subject matter of Examples 1-8 includes, wherein each of the parallel cooling branches includes at least one heat generating component, at least some of the parallel cooling branches including an adjustable valve downstream of the corresponding heat generating component.

In Example 10, the subject matter of Examples 8-9 includes, wherein the adjustable valves are located in a single valve block.

In Example 11, the subject matter of Examples 1-10 includes, wherein each of the parallel cooling branches includes at least one heat generating component, at least one of the parallel cooling branches including a restrictor upstream or downstream of the corresponding heat generating component.

In Example 12, the subject matter of Examples 2-11 includes, a connection between the cooling system and a cathode air intake of the fuel cell.

In Example 13, the subject matter of Example 12 includes, wherein the connection between the cooling system and the cathode air intake comprises a coolant expansion tank.

In Example 14, the subject matter of Examples 2-13 includes, a fuel cell inlet air intercooler and a hydrogen evaporator located in one of the parallel branches.

Example 15 is a method of operating an aircraft fuel cell cooling system, the method comprising: circulating coolant through the cooling system using a coolant pump; directing coolant from the coolant pump through a radiator to reject heat to ambient air; directing coolant from the radiator to a cooler zone downstream of the radiator, the cooler zone comprising a plurality of parallel cooling branches; directing coolant from the cooler zone to a warmer zone downstream of the cooler zone, the warmer zone including a fuel cell stack; and operating an adjustable bypass valve to provide to provide an adjustable flow of coolant to the warmer zone from upstream of the radiator, bypassing the radiator and the cooler zone.

In Example 16, the subject matter of Example 15 includes, controlling an amount of airflow through the radiator to adjust the amount of heat rejected by the cooling system.

In Example 17, the subject matter of Examples 15-16 includes, wherein each of the parallel cooling branches includes at least one heat generating component, at least some of the parallel cooling branches including one or more adjustable valves, the method further comprising: operating the adjustable valves to control the flow of coolant through the corresponding cooling branches.

Example 18 is a non-transitory machine-readable medium including instructions which, when read by a machine, cause the machine to perform operations for cooling an aircraft fuel cell using a cooling system, the operations comprising: circulating coolant through the cooling system using a coolant pump; directing coolant from the coolant pump through a radiator to reject heat to ambient air; directing coolant from the radiator to a cooler zone downstream of the radiator, the cooler zone comprising a plurality of parallel cooling branches; directing coolant from the cooler zone to a warmer zone downstream of the cooler zone, the warmer zone including a fuel cell stack; and operating an adjustable bypass valve to provide an adjustable flow of coolant to the warmer zone from upstream of the radiator, bypassing the radiator and the cooler zone.

In Example 19, the subject matter of Example 18 includes, wherein the operations further comprise: controlling an amount of airflow through the radiator to adjust the amount of heat rejected by the cooling system.

In Example 20, the subject matter of Examples 18-19 includes, wherein each of the parallel cooling branches includes at least one heat generating component, at least some of the parallel cooling branches including one or more adjustable valves, the operations further comprising: operating the adjustable valves to control the flow of coolant through the corresponding cooling branches.

Example 21 is at least one machine-readable medium including instructions that, when executed by processing circuitry, cause the processing circuitry to perform operations to implement of any of Examples 1-20. Example 22 is an apparatus comprising means to implement of any of Examples 1-20. Example 23 is a system to implement of any of Examples 1-20. Example 24 is a method to implement of any of Examples 1-20.

As a person skilled in the art will recognize from the previous detailed description and from the figures and claims, modifications and changes can be made to the examples of the invention disclosed herein without departing from the scope of this invention defined in the following claims.

What is claimed is:

1. A cooling system for a vehicle, comprising:
a coolant pump to circulate coolant through the cooling system;
a radiator to reject heat to ambient air;
a cooler zone downstream of the radiator and comprising a plurality of parallel cooling branches;
a warmer zone downstream of the cooler zone, the warmer zone including a power supply unit; and
an adjustable bypass valve arranged to provide an adjustable flow of coolant to the warmer zone from upstream of the radiator, bypassing the radiator and the cooler zone.

2. The cooling system of claim 1, wherein the power supply unit is a fuel cell.

3. The cooling system of claim 1, further comprising a restrictor arranged to provide coolant to the warmer zone from downstream of the radiator.

4. The cooling system of claim 3, further comprising a control mechanism to control an amount of airflow through the radiator.

5. The cooling system of claim 4, wherein the control mechanism comprises an adjustable aerodynamic fairing.

6. The cooling system of claim 4, wherein the control mechanism comprises a variable-speed or variable-pitch fan.

7. The cooling system of claim 5, further comprising a restrictor arranged to provide coolant to the warmer zone from downstream of the radiator.

8. The cooling system of claim 1, wherein each of the parallel cooling branches includes at least one heat generating component, at least some of the parallel cooling branches including an adjustable valve upstream of the corresponding heat generating component.

9. The cooling system of claim 8, wherein the adjustable valves are located in a single valve block.

10. The cooling system of claim 1, wherein each of the parallel cooling branches includes at least one heat generating component, at least some of the parallel cooling branches including an adjustable valve downstream of the corresponding heat generating component.

11. The cooling system of claim 1, wherein each of the parallel cooling branches includes at least one heat generating component, at least one of the parallel cooling branches including a restrictor upstream or downstream of the corresponding heat generating component.

12. The cooling system of claim 2, further comprising a connection between the cooling system and a cathode air intake of the fuel cell.

13. The cooling system of claim 12, wherein the connection between the cooling system and the cathode air intake comprises a coolant expansion tank.

14. The cooling system of claim 2, further comprising a fuel cell inlet air intercooler and a hydrogen evaporator located in one of the parallel branches.

15. A method of operating an aircraft fuel cell cooling system, the method comprising:
circulating coolant through the cooling system using a coolant pump;
directing coolant from the coolant pump through a radiator to reject heat to ambient air;
directing coolant from the radiator to a cooler zone downstream of the radiator, the cooler zone comprising a plurality of parallel cooling branches;
directing coolant from the cooler zone to a warmer zone downstream of the cooler zone, the warmer zone including a fuel cell stack; and
operating an adjustable bypass valve to provide to provide an adjustable flow of coolant to the warmer zone from upstream of the radiator, bypassing the radiator and the cooler zone.

16. The method of claim 15, further comprising controlling an amount of airflow through the radiator to adjust the amount of heat rejected by the cooling system.

17. The method of claim 15, wherein each of the parallel cooling branches includes at least one heat generating component, at least some of the parallel cooling branches including one or more adjustable valves, the method further comprising:
operating the adjustable valves to control the flow of coolant through the corresponding cooling branches.

18. A non-transitory machine-readable medium including instructions which, when read by a machine, cause the machine to perform operations for cooling an aircraft fuel cell using a cooling system, the operations comprising:
circulating coolant through the cooling system using a coolant pump;
directing coolant from the coolant pump through a radiator to reject heat to ambient air;
directing coolant from the radiator to a cooler zone downstream of the radiator, the cooler zone comprising a plurality of parallel cooling branches;
directing coolant from the cooler zone to a warmer zone downstream of the cooler zone, the warmer zone including a fuel cell stack; and
operating an adjustable bypass valve to provide an adjustable flow of coolant to the warmer zone from upstream of the radiator, bypassing the radiator and the cooler zone.

19. The non-transitory machine-readable medium of claim 18, wherein the operations further comprise:
controlling an amount of airflow through the radiator to adjust the amount of heat rejected by the cooling system.

20. The non-transitory machine-readable medium of claim 18, wherein each of the parallel cooling branches includes at least one heat generating component, at least some of the parallel cooling branches including one or more adjustable valves, the operations further comprising:
operating the adjustable valves to control the flow of coolant through the corresponding cooling branches.
